(19) United States
(12) Patent Application Publication
(10) Pub. No.: US 2010/0231358 A1
(43) Pub. Date: Sep. 16, 2010

(54) AFFIXED AND AFFIXABLE PRODUCT INFORMATION SYSTEM AND METHOD

(76) Inventor: David M. Mello, Concord, MA (US)

Correspondence Address: David M. Mello, 41 Old Bridge Road, Concord, MA, 01742, US

(21) Appl. No.: 12/725,433

(22) Filed: Mar. 16, 2010

Related U.S. Application Data
(60) Provisional application No. 61/160,675, filed on Mar. 16, 2009.

(51) Int. Cl. H04Q 5/22

(52) U.S. Cl. 340/10.1

(57) ABSTRACT

A product information system and method are provided. A container or label, for example, can include an information system that includes stored product information, a speaker, and an activation mechanism that makes audible the product information. The foregoing can be provided for medication and medical device packaging, as well with other types of packaging, devices, and products.

### CROSS REFERENCES TO RELATED APPLICATIONS

This application claims the benefit of priority under 35 U.S.C. §119(e) from co-pending commonly owned U.S. provisional patent application Ser. No. 61/160.675, entitled AFFIXED AND AFFIXABLE PRODUCT INFORMATION SYSTEM AND METHOD, filed Mar. 16. 2009, the disclosure of which is incorporated herein in its entirety by reference.

### FIELD OF INTEREST

The present inventive concepts relate to the field containers, packaging, and labels, particularly in the medical field, as well as containers and packaging used in other fields.

### BACKGROUND

As a general rule, medications come with both separately printed instructions, labels affixed to the medication container or both. The instructions on medical labels can be so small that they are not readable by those with normal vision, let alone those with more limited or no vision.

When separately printed instructions are provided with a medication or medical device they can also be primed in very small font—and can also be difficult to read. Even if such separately printed instructions are easy to read, once the get separated from the medication, e.g., lost or thrown away, the user of the medication or medical device can left with the very difficult to read instructions affixed to the medication or medical device—if one is provided.

The same problems can exist with other items that are packaged and include instructions or other important information.

### SUMMARY OF INVENTION

In accordance with one aspect of the present disclosure, provided is an information system integral with, or affixed or affixable to a container or package, the information system includes stored product information, an audio output device, and an activation mechanism that makes audible the product information.

In accordance with another aspect of the present disclosure, provided is a container or package having an information system that includes stored product information, an audio output device, and an activation mechanism that makes audible the product information.

The information system can be integrated into a wall of the container.

The information system can be integrated into a bottom of the container.

The information system can be integrated into a cap or cover of the container.

In accordance with another aspect of the present disclosure, provided is a label that can be affixed to a container or package, the label having an information system that includes stored product information, an audio output device, and an activation mechanism that makes audible the product information.

In anyone of the foregoing, the container can be a medical container and the product information can be medical information.

In anyone of the foregoing, the medical information can include an expiration date.

In anyone of the foregoing, the medical information can include usage instructions.

In anyone of the foregoing, the medical information can indicate a time the container was last opened.

In anyone of the foregoing, the medical information can include dosage amounts.

In anyone of the foregoing, the medication information can include warnings.

In anyone of the foregoing, the information system can be multilingual.

In anyone of the foregoing, the medical container can be a pill bottle.

In anyone of the foregoing, the medical container can be a tube of ointment.

In anyone of the foregoing, the medical container can be a spray bottle.

In anyone of the foregoing, the activation mechanism can be a pressure responsive mechanism.

In anyone of the foregoing, the pressure responsive mechanism can include a button.

In anyone of the foregoing, the pressure responsive mechanism can include a switch.

In anyone of the foregoing, the activation mechanism can include a voice activation mechanism.

In anyone of the foregoing, the activation mechanism can include a motion sensor.

In anyone of the foregoing, the activation mechanism can include a bioinformatics sensor.

In anyone of the foregoing, the label can be a medical container label and the product information can be medical information.

Otherwise, the container or package can hold food or other goods. In the case of food, the product information can he information regarding the expiration data and/or instructions relating to the preparation (e.g., recipes, cooking instructions, etc.) and/or storage (e.g., “refrigerate after opening”). In the case of clothing or other goods, the information could include use, care, assembly, and/or cleaning instructions, e.g., “wash in cold water, tumble dry low.”

Also in accordance with aspects of the present invention, methods for making and/or using any of the foregoing can be provided.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. In the drawings:

FIG. 1 is a view of an embodiment of a container having an information system, in accordance with aspects of the present invention.

FIG. 2 is a diagram of an embodiment of a circuit that can be used to implement the information system of FIG. 1, in accordance with aspects of the present invention.

FIGS. 3-5 are views of other embodiments of a container having an information system in accordance with the present invention, in accordance with aspects of the present invention.

FIG. 6 is a view of an embodiment of an information system comprising an audible reader, in accordance with aspects of the present invention.

FIG. 7 is a view of a container having an information system on a container attachable container segment, in accordance with aspects of the present invention.

FIG. 8 is a view of a box having an information system, in accordance with aspects of the present invention.

FIGS. 9A and 9B are views of embodiments of food containers having an information system, in accordance with aspects of the present invention.

### DETAILED DESCRIPTION OF PREFERRED EMBODIMENT

It will be understood that, although the terms first, second, etc. may he used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements may be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

For describing aspects of the present invention, a medication application will be used. Those skilled in the art will appreciated that the present invention can, however, be applied in many different contexts, e.g., food containers.

In the present embodiment, the medication could be prescription or over the counter. Some medication examples include prescribed pills (e.g., antibiotics, pain medication, sleeping pills, blood thinners, acid reflux pills, etc.), over the counter pills (e.g., aspirin, Tylenol, Advil, vitamins), liquid medicines (e.g., cough and cold syrups), and tablets (e.g., sore throat lozenges).

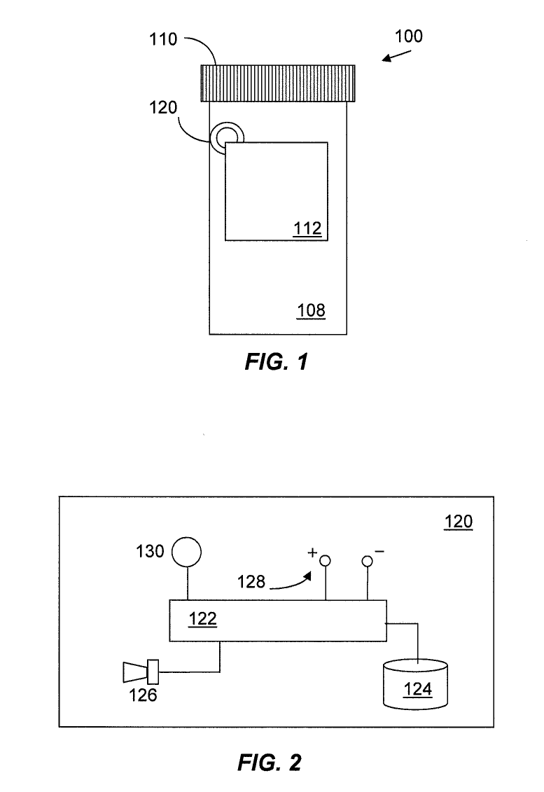

FIG. 1 shows an example of a medication container in the form of a plastic pill bottle 100. The bottle 100 includes a vessel 108, a cap 110, and a label 112. The label 112 includes information system 120. The information system 120 is configured to audibly provide product information. Information system 120 includes a body, within which various structural and functional elements may be housed, such as those described below with respect to FIG. 2.

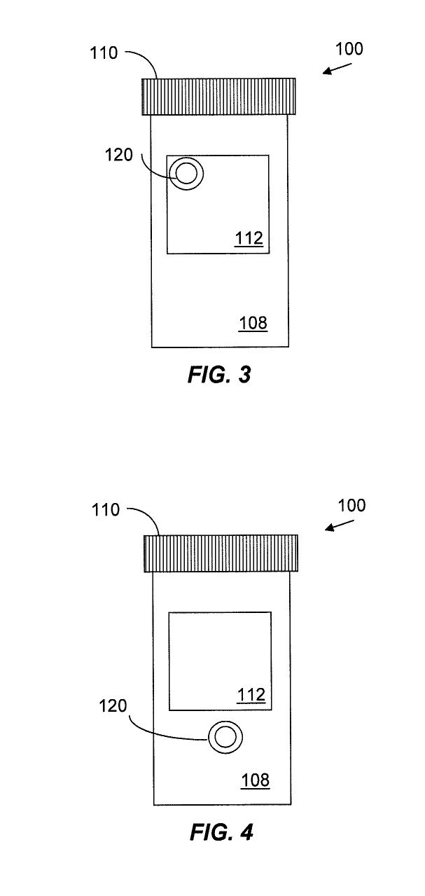

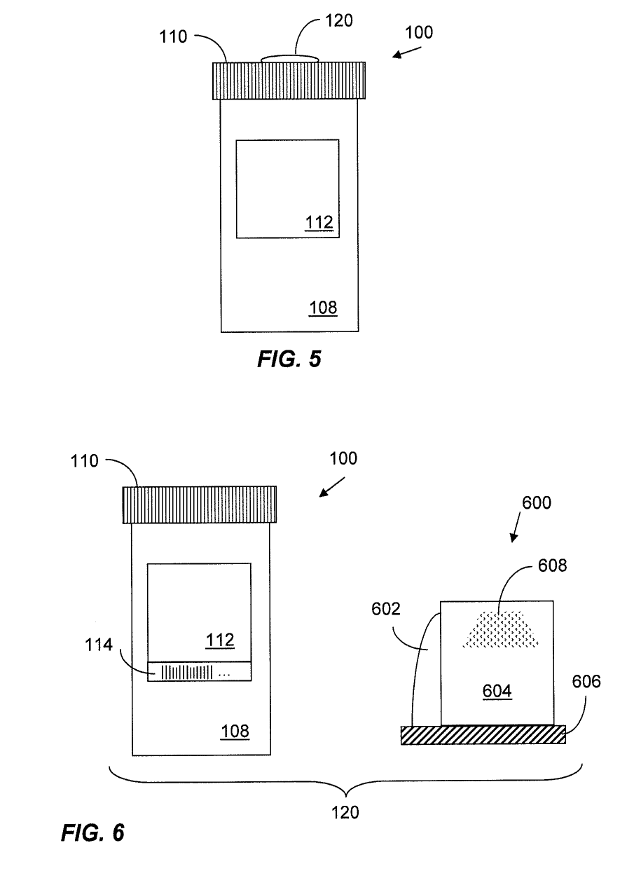

The information system 120 is relatively small, such that it can easily be integrated into the label 112, or under the label 112 in other embodiments. In yet other embodiments, information system 120 can be integral with the container, e.g., vessel 108 or cap 110, as shown in FIGS. 4-5. The container 100 need not be a pill bottle. In other embodiments, the container could be a tube, a jar, a blister pack, a box, or a pre-dosed injection syringe (e.g., an Epi Pen). In other embodiments, the container could be something else.

FIG. 2 shows an embodiment of information system 120, which includes a microprocessor 122, a storage device (e.g., non-transitory memory) 124, a speaker 126, a battery 128, and an activation mechanism 130, in this embodiment. Here, the activation mechanism is a button 130, but it he a switch or other such mechanism.

A variety of types of information can be stored in the memory 124 and made audible through the speaker 126 in response to activation of the activation mechanism 130. The information can include product information. For example, the product information can include the name of the medication, date of expiration, dosage information, usage information, and or warnings.

For instance, presume that the medication is a prescription of Codeine. Depressing the button 130 could cause the microprocessor 122 to access the storage device 124 and output through the speaker: “THIS MEDICATION IS CODEINE.”

Presume that the patient should not drink alcohol with the medication, nor should they drive or operate heavy machinery. Depressing the button 130 could cause the microprocessor 122 to access the storage device 124 and output through the speaker 126 the following: “TWO WARNINGS. FIRST WARNING: DO NOT CONSUME ALCOHOL WITH THIS MEDICATION. SECOND WARNING: DO NOT DRIVE OR OPERATE HEAVY MACHINERY AFTER TAKING.”

As another example, presume that medication is to be used to address pain. Depressing the button 130 could cause the microprocessor 122 to access the storage device 124 and output through the speaker 126 the following: “USE ONLY AS NEEDED TO ADDRESS PAIN.”

For instance, presume that the dosage is 300 mg. Depressing button 130 could cause the microprocessor 122 to access the storage device 124 and output through the speaker 126 the following: “THE ADULT DOSAGE IS ONE 300 MILLIGRAM PILL EVERY 8 HOURS.”

For instance, there could be instructions for taking the medication. Depressing the button 130 could cause the microprocessor 122 to access the storage device 124 and output through the speaker 126 the following: “TAKE AFTER EATING: DO NOT TAKE ON AN EMPTY STOMACH.”

The information system could be made to be singular in message, where a different information system is provided for each type of message. In other embodiments, the information system 120 could be configured to provide multiple types of information, such as those described above. When the information provides multiple types of information, multiple activations of the activation mechanism can cause the information system to scroll through the different types of messages. Or the system could just automatically scroll in other embodiments.

For example, a counter could be included and increment with each activation to scroll though messages as follows: 1=medication name; 2=warnings: 3=usage information; 4=dosage; 5=instructions, and so on.

In some embodiments, the information system can be multilingual, e.g., to include English and Spanish. In such a case, the messages can be provided in each of a plurality of languages.

In other embodiments, the activation system 30 can take other forms, such as a voice activation mechanism; a motion sensor: and/or a bioinformatics sensor, as examples, each of which could control a switch.

For example, information system 120 could include a microphone to receive voice signals for use by a voice activation sensor. In such a case, activation mechanism 130 could be or include or be the microphone. For instance, if the user says “DOSAGE” the information system could return “THE ADULT DOSAGE IS ONE 300 MILLIGRAM PILL EVERY 8 HOURS.” It would work similarly for other types of product information.

A motion sensor could be included in or be the activation mechanism 130, such that a shake of the container 100 causes product information to be audibly provided. Successive shakes could cause scrolling through different types of product information stored in memory 124.

A finger/thumb print sensor could be used to sense a bioinformatics information, so could be, or be included in, the activation mechanism 130. Upon sensing such information messages can be audibly delivered.

FIG. 3 can be interpreted in two ways. First, FIG. 2 can be used to show an embodiment where the information system 120 is formed within the label. Second, the embodiment could be used to show the information system 120 disposed under the label. The drawing in FIG. 3 would suffice in either case. The label is affixed to vessel 108.

A label 112, having the information system formed therein, can include multiple layers, and the information system can be disposed between layers. In other embodiments, an opening in the label can be defined and the information system 120 can be disposed to be at least partially exposed through the opening.

In FIG. 4, the information system 120 is affixed to the vessel 108. In such a case, information system 120 can include an adhesive backing that enables the information system 120 to be affixed to the vessel 108 (or label 112 or cap 110).

In FIG. 5, the information system 120 is integral with or adhered to cap 110.

FIG. 6 provides a perspective view of an information system 120 that comprises an audible reader 600. In this embodiment, a coded tag 114 is added to the container 100, label 112, vessel 108, or cap 110. The coding of the tag 114 indicates product information for the contents of the package, which causes reader 600 to make audible the product information upon reading tag 114.

In this embodiment, reader 600 includes a scanner 602 in a housing 604. The scanner 602 is configured to read the tag 114. The reader 600 can include a base 606 that enables the reader to stably sit on a flat surface. An audio output device 608, e.g., a speaker, is provided to output the product information.

In various embodiments, the tag 114 could include bar coded information and the scanner 602 could be a bar code reader. The reader 600 includes an internal processor (not shown) and memory (not shown). The processor interprets tag information provided via the scanner 602 and from that read information outputs audio product information through the speaker 608.

The product information can be coded in the tag or stored in the memory of reader 600, or a combination of both. For example, standard warnings could be stored in memory and triggered based on the coding of the tag. Information identifying the medication in container 100 could be coded in the tag 114 itself, and upon determining the identity of the medication, the reader could output associated stored product information stored in its memory.

Other variations can be implemented without departing from the present invention. For example, the reader 600 could be updated via a wired or wireless network, example with updated product information. This could be done via the Internet, as an example. In such cases, the reader could includes a port or other interface that enables connection and/or communication with a computer through which the downloads can occur. In other embodiments, the reader could wirelessly connect to the Internet, a satellite network, cell phone network, etc. to receive downloads and updates.

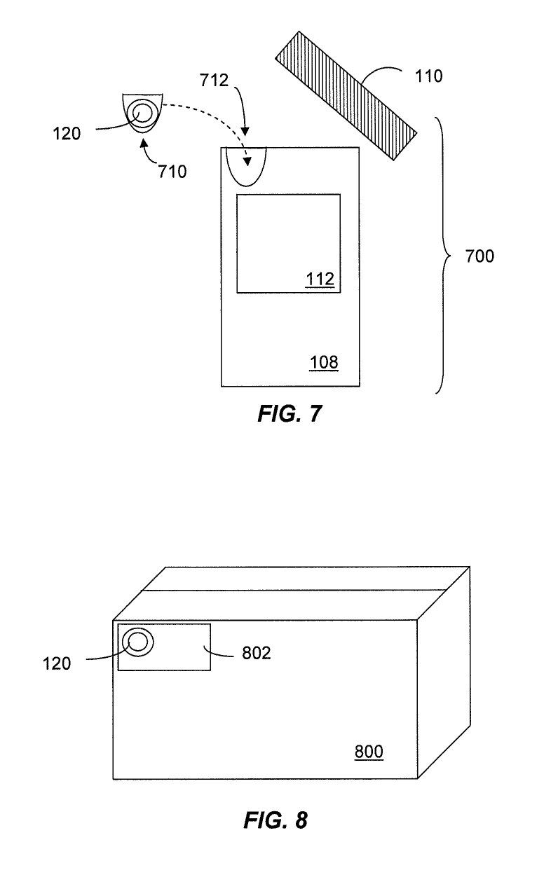

FIG. 7 is a front view of a plastic pill bottle 700 having an information system 120 on an attachable container segment 710. In this embodiment, the container is in the form of a plastic pill bottle 700. The bottle 700 includes a vessel 108, a cap 110, an attachable container segment 710, and a label 112. The attachable container segment 710 includes information system 120. The information system 120 is configured to audibly provide product information, as described above.

In the preferred form, the vessel 108 defines an opening 712 within which the attachable container segment 710 can be disposed. The opening 712 can include a groove that receives the attachable container segment 710, which can be slid into the groove. In this embodiment, the attachable container segment 710 locks into place once inserted, and preferably cannot be removed thereafter. But in other embodiments, the attachable container segment 710 could be made removable.

FIG. 8 is a view of a box 800 having an information system 120 attached thereto or embedded therein, in accordance with aspects of the present invention. The information system 120 can be attached to the box using an adhesive label 802. As examples, the information system 120 may be configured to audibly inform a handler of the box of handling instructions, contents of the box, assembly and/or usage instructions, warnings, weight, environmental or hazard considerations, storage considerations, expiration information, and so on.

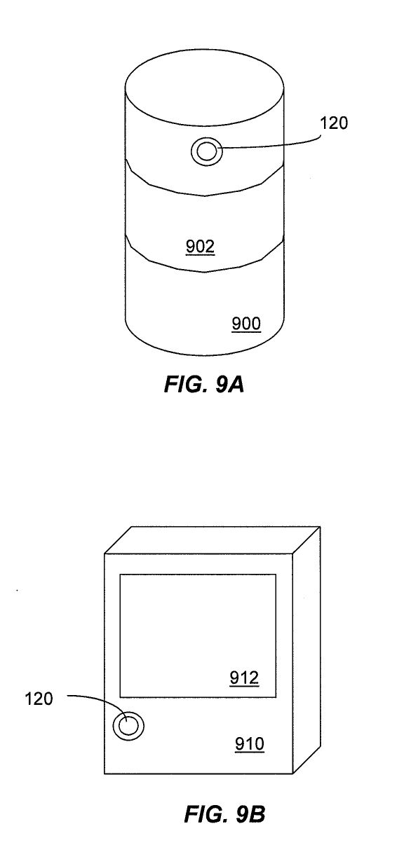

FIGS. 9A and 9B are views of embodiments of food containers having an information system 120, in accordance with aspects of the present invention.

In FIG. 9A the food container is a can 900, to which an information system 120 is attached. The can 900 can include a picture or label 902 identifying its contents, as well as other information, such as cooking instructions, recipes, and so on. As examples, the information system 120 may be configured to audibly inform a user of the can of handling instructions, contents of the can (e.g., ingredients), health information (e.g., amounts of servings, calories, salt, cholesterol, etc.), cooking instructions, warnings, weight, storage considerations, expiration information, and so on.

In FIG. 9B the food container is a box 910, to which an information system 120 is attached. The box 910 can include a picture or label 912 identifying its contents, as well as other information, such as cooking instructions, recipes, and so on. As examples, the information system 120 may be configured to audibly inform a user of the box of handling instructions, contents of the box (e.g., ingredients), health information (e.g., amounts of servings, calories, salt, cholesterol, etc.), cooking instructions, warnings, weight, storage considerations, expiration information, and so on.

In various embodiments, rather than the affixed information system 120, a bar coded label could be attached to the box 800, can 900, and/or box 910, and read by a bar code reader 600 with speaker, as described above.

While the foregoing has described what are considered to be the best mode and/or other preferred embodiments, it is understood that various modifications may be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope or each claim.

What is claimed is:

1. A product information system, comprising:
a body affixable to a container: and within said body:
a memory having stored product information connected to a microprocessor:
an output device, and
an activation mechanism connected to the microprocessor that outputs the product information in response to a stimulus.

2. The product information system of claim 1, wherein the body is a depressible button.

3. The product information system of claim 2, wherein the depressible button includes an adhesive material on an external surface.

4. The product information system of claim 1, wherein the body is attached to a label.

5. The product information system of claim 1, wherein the body is attached to a cover or cap of the container.

6. The product information system of claim 1, wherein the body is integral with the container.

7. The product information system of claim 1, wherein the product information is medical information.

8. The product information system of claim 7, wherein the medical information includes warning information.

9. The product information system of claim 7, wherein the medical information includes usage information, and the usage information includes dosage information.

10. The product information system of claim 1, wherein the product information is provided in multiple languages.

11. The product information system of claim 8, wherein the activation mechanism enables selection of a language for output of the product information.

12. The product information system of claim 1, wherein the output device includes a speaker.

13. A container including a product information system, the product information system comprising:
a microprocessor;
a memory having stored product information connected to the microprocessor;
an audio output device, and
an activation mechanism connected to the microprocessor that makes audible the product information via the audio output device in response to a stimulus.

14. The container of claim 13, wherein the information system is integrated into a vessel of the container.

15. The container of claim 13, wherein the information system is integrated into a cap of the container.

16. The container of claim 13, wherein the information system is integrated into an insert that fits into the container.

17. The container of claim 13, wherein the container is a Food container.

18. The container of claim 13, wherein the container is a medication container.

19. A product information label comprising a product information system, the product information system comprising:
a memory having stored product information;
an audio output device, and
an activation mechanism that makes audible the product information via the audio output device in response to a stimulus.

20. The label of claim 19, wherein the product information is medication information.
